(19) United States
(12) Patent Application Publication
(10) Pub. No.: US 2021/0107602 A1
(43) Pub. Date: Apr. 15, 2021

(54) Foil Board

(71) Applicant: Ricky Karr, Carslbad, CA (US)

(72) Inventor: Ricky Karr, Carslbad, CA (US)

(21) Appl. No.: 17/064,418

(22) Filed: Oct. 6, 2020

Related U.S. Application Data
(60) Provisional application No. 62/912,869, filed on Oct. 9, 2019.

(51) Int. Cl. B63B 32/64; B63B 32/10; B63B 1/24; B63B 11/00; B63H 21/17; B60L 50/60

(52) U.S. Cl. CPC B63B 32/64; B63B 32/10; B63B 1/246; B60L 2200/32; B63H 21/17; B63B 1/248; B60L 50/66; B63B 11/00

(57) ABSTRACT

A foil board with two hydrofoils is described. A first version has a single mast supporting both a leading hydrofoil wing and a trailing stabilizer wing connected to each other with a fuselage. A second version has two masts, with a front mast supporting a stabilizer wing and a rear mast that supports a hydrofoil, or with the front mast supporting the hydrofoil and the rear mast supporting the stabilizer wing. Both versions have a removable propulsion unit, which allows the user to easily remove the propulsion unit for cleaning, maintenance, repair, or even to remove it temporarily so that the foil board can be used for non-motorized applications.

### CROSS REFERENCE TO RELATED APPLICATIONS

This application claims priority to U.S. Provisional No. 62/912,869, filed Oct. 9, 2019, the contents of which are incorporated by reference into this application.

### STATEMENT REGARDING FEDERALLY SPONSORED RESEARCH OR DEVELOPMENT

This invention was not federally sponsored.

### INVENTOR

Ricky Karr, resident of Carlsbad, Calif., and citizen of USA.

### ATTORNEY DOCKET NO.

Karr-Foil Board

### BACKGROUND OF THE INVENTION

### Field of the Invention

This invention relates to foil boards designed for traveling across bodies of water, and more specifically, to a modular foil board with two foils. One embodiment has a single mast supporting both a leading hydrofoil wing and a trailing stabilizer wing connected to each other with a fuselage. A second version has two masts, with a front mast supporting a stabilizer wing and a rear mast that supports a hydrofoil. Both versions are modular and have a removable propulsion unit such that the motor is easily removable for maintenance, repair, or replacement, and can also allow a user to remove the propulsion unit when the foil board is used for non-motorized activities such as kite boarding and foil surfing.

Motor-propelled foil boards have been available for several years. The basic concept is that the board is propelled forward fast enough so that the board portion rises out of the water, and both the board and the rider are supported by a hydrofoil that is connected to the board by a mast.

A problem with the current design of foil boards is that balancing on a single hydrofoil is difficult, with the user of the invention having to put a lot of energy into balancing the board through weight distribution. Another problem is that with the propulsion unit built into the mast or even the foil itself, removing the propulsion unit for cleaning, inspection, maintenance, repair or replacement can be difficult and time consuming, as it often requires taking the entire foil board apart. Another problem is that with the propulsion unit built in as an integral part of the foil board apparatus, a user has to purchase a second, non-motorized foil board to participate in non-motorized foil sports such as kite foiling and foil surfing (of the user has to deal with the excessive drag caused by having the propulsion unit provided a lot of drag and no propulsion).

Thus, there has existed a long-felt need for devices that allow for easier removal of the propulsion unit and a more stable ride. The current invention provides just such a solution by having a foil board with two hydrofoils and an easily removable propulsion unit. A first version has a single mast supporting both a leading hydrofoil wing and a trailing stabilizer wing connected to each other with a fuselage. A second version has two masts, with a front mast supporting a stabilizer wing and a rear mast that supports a hydrofoil. Both versions have a removable propulsion unit, which allows the user to easily remove the propulsion unit for cleaning, maintenance, repair, or even to remove it temporarily so that the foil board can be used for non-motorized applications.

### OBJECTS OF THE INVENTION

It is therefore an object of the present invention to provide a foil board with a propulsion unit that is easily removable.

A further object of the invention is to provide a modular assembly, whereby individual components of the system can be removed easily and effectively, without requiring the entire foil apparatus to be removed from the board.

An additional object of the invention is to provide a foil board with a more stable ride through the use of multiple foils.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.
It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a one-mast version of the invention.

FIG. 2 is a perspective view of a two-mast version of the invention.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

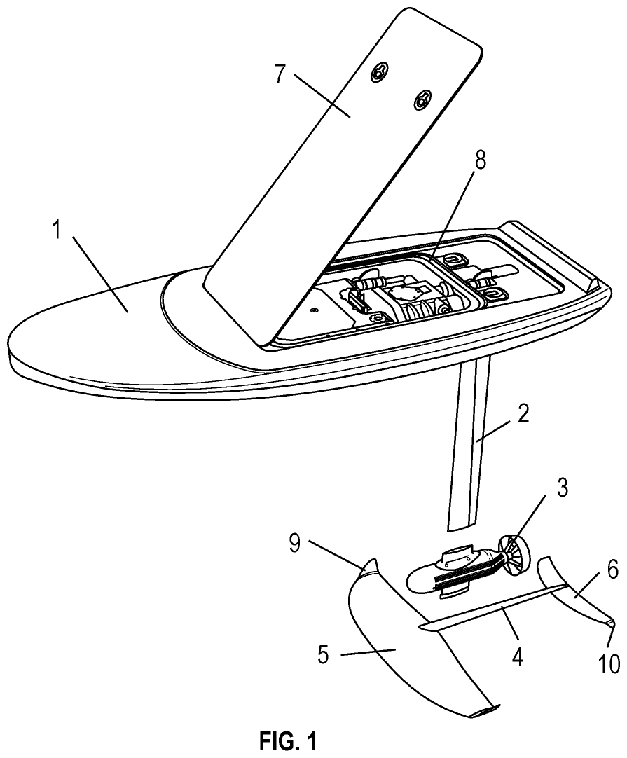

FIG. 1 is a perspective view of a one-mast version of the invention. The board 1 has a battery compartment 8 which is covered by a watertight cover 7. A mast 2 extends from the bottom of the board 1 into a sleeve of a removable propulsion unit 3, which in turn, mates with a sleeve in a fuselage 4. The fuselage 4 has a front and rear, with the front terminating in a hydrofoil wing 5, with hydrofoil winglets 9.

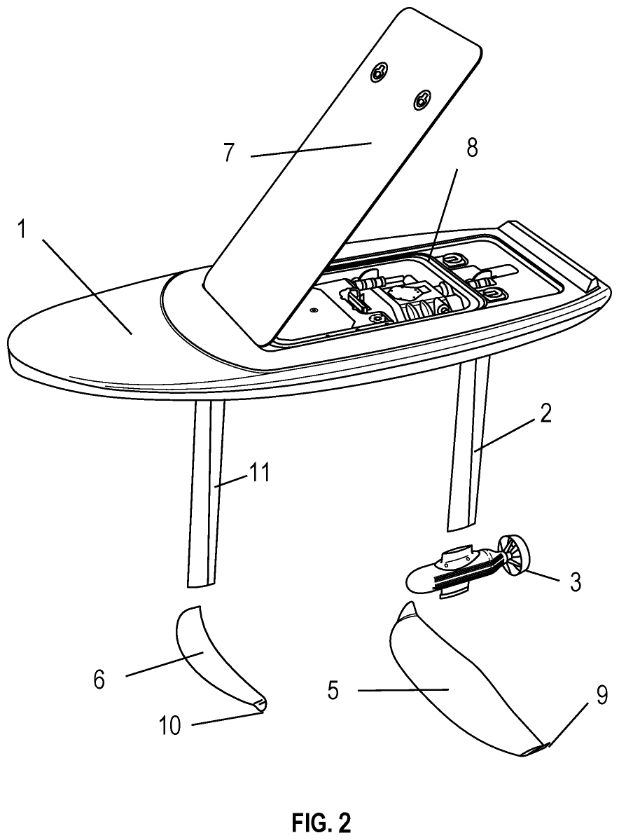

FIG. 2 is a perspective view of a two-mast version of the invention. The board 1 has a front mast 11 and a rear mast 12. The propulsion unit 3 is attached to the rear mast 12, which also supports the hydrofoil wing 5. The front mast 11 supports the stabilizer wing 6.

Another embodiment of the idea expressed in FIGS. 1 and 2 is that the hydrofoil and the stabilizing wing could be exchanged in their order, such that either version could a “hydrofoil—stabilizing wing”, or “stabilizing wing—hydrofoil”.

A still further embodiment calls for the winglets to be rotated from a “downward” position to an “upward” position depending on the conditions.

In a preferred embodiment, the invention provides a foil board with a single mast, where the invention comprises a board, a mast, a removable propulsion unit, and a fuselage, where the mast is removably attached to the board, where the mast is removably attached to an upper part of the propulsion unit and the fuselage is removably attached to a lower part of the propulsion unit, and there the fuselage has a hydrofoil wing and a stabilizer wing, where the hydrofoil wing is removably connected to a front fuselage part and the stabilizer wing is removably connected to a back fuselage part, where the hydrofoil wing has at least two hydrofoil winglets and the stabilizer wing has at least two stabilizer winglets.

The winglets can be oriented in either an upward or downward direction, such that four possible scenarios are envisioned: where the hydrofoil winglets turn in an upward direction and the two stabilizer winglets turn in an upward direction, where the two hydrofoil winglets turn in a downward direction and the two stabilizer winglets turn in a downward direction, where the two hydrofoil winglets turn in a downward direction and the two stabilizer winglets turn in an upward direction, and, where the two hydrofoil winglets turn in an upward direction and the two stabilizer winglets turn in downward direction.

The invention also has a battery compartment with a waterproof, detachable cover, where the battery compartment comprises a battery, a circuit board, and a plurality of electrical connections, where the plurality of electrical connection for a connection between the battery and the propulsion unit.

In a second embodiment, the invention comprises a board, a forward mast, a rear mast, a propulsion unit, a stabilizer wing and a hydrofoil wing, where the rear mast is removably attached to the board, where the rear mast is removably attached to an upper part of the propulsion unit and the hydrofoil wing is removably attached to a lower part of the propulsion unit, and there the forward mast is removably attached to the stabilizer wing, and where the forward mast is removably attached to the board, where the hydrofoil wing has at least two hydrofoil winglets and the stabilizer wing both has at least two stabilizer winglets.

As with the previous embodiment, the winglets can be oriented in either an upward or downward direction, such that four possible scenarios are envisioned: where the hydrofoil winglets turn in an upward direction and the two stabilizer winglets turn in an upward direction, where the two hydrofoil winglets turn in a downward direction and the two stabilizer winglets turn in a downward direction, where the two hydrofoil winglets turn in a downward direction and the two stabilizer winglets turn in an upward direction, and, where the two hydrofoil winglets turn in an upward direction and the two stabilizer winglets turn in downward direction.

And, also as is featured in the previous embodiment, the invention also has a battery compartment with a waterproof, detachable cover, where the battery compartment comprises a battery, a circuit board, and a plurality of electrical connections, where the plurality of electrical connection for a connection between the battery and the propulsion unit.

A third embodiment combines a board, a forward mast, a rear mast, a propulsion unit, a stabilizer wing and a hydrofoil wing, where the board is removably attached to both the forward mast and the rear mast, where the rear mast is removably attached to an upper part of the propulsion unit and the hydrofoil wing is removably attached to a lower part of the propulsion unit, and there the forward mast is removably attached to the stabilizer wing, where the hydrofoil wing has at least two hydrofoil winglets and the stabilizer wing both has at least two stabilizer winglets.

As with the previous embodiment, the winglets can be oriented in either an upward or downward direction, such that four possible scenarios are envisioned: where the hydrofoil winglets turn in an upward direction and the two stabilizer winglets turn in an upward direction, where the two hydrofoil winglets turn in a downward direction and the two stabilizer winglets turn in a downward direction, where the two hydrofoil winglets turn in a downward direction and the two stabilizer winglets turn in an upward direction, and, where the two hydrofoil winglets turn in an upward direction and the two stabilizer winglets turn in downward direction.

And, also as is featured in the previous embodiment, the invention also has a battery compartment with a waterproof, detachable cover, where the battery compartment comprises a battery, a circuit board, and a plurality of electrical connections, where the plurality of electrical connection for a connection between the battery and the propulsion unit.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

Reference numbers used.

### REFERENCE NUMBERS USED

1. Board
2. Mast
3. Removable propulsion unit
4. Fuselage
5. Hydrofoil wing
6. Stabilizer wing
7. Cover
8. Battery compartment
9. Hydrofoil winglet
10. Stabilizer winglet
11. Forward mast
12. Rear mast

That which is claimed:

1. A foil board, comprising: a board, a mast, a removable propulsion unit, and a fuselage, where the mast is removably attached to the board, where the mast is removably attached to an upper part of the propulsion unit and the fuselage is removably attached to a lower part of the propulsion unit, and there the fuselage has a hydrofoil wing and a stabilizer wing.

2. The foil board of claim 1, where the hydrofoil wing is removably connected to a front fuselage part and the stabilizer wing is removably connected to a back fuselage part.

3. The foil board of claim 2, where the hydrofoil wing has at least two hydrofoil winglets and the stabilizer wing has at least two stabilizer winglets.

4. The foil board of claim 3, where the at least two hydrofoil winglets turn in an upward direction, and the at least two stabilizer winglets turn in an upward direction.

5. The foil board of claim 3, where the at least two hydrofoil winglets turn in a downward direction, and the at least two stabilizer winglets turn in a downward direction.

6. The foil board of claim 3, where the at least two hydrofoil winglets turn in a downward direction, and the at least two stabilizer winglets turn in an upward direction.

7. The foil board of claim 3, where the at least two hydrofoil winglets turn in an upward direction, and the at least two stabilizer winglets turn in downward direction.

8. The foil board of claim 7, additionally comprising a battery compartment with a waterproof, detachable cover, where the battery compartment comprises a battery, a circuit board, and a plurality of electrical connections, where the plurality of electrical connection for a connection between the battery and the propulsion unit.

9. A foil board, comprising, a board, a forward mast, a rear mast, a propulsion unit, a stabilizer wing and a hydrofoil wing, where the rear mast is removably attached to the board, where the rear mast is removably attached to an upper part of the propulsion unit and the hydrofoil wing is removably attached to a lower part of the propulsion unit, and there the forward mast is removably attached to the stabilizer wing, and where the forward mast is removably attached to the board.

10. The foil board of claim 9, where the hydrofoil wing has at least two hydrofoil winglets and the stabilizer wing both has at least two stabilizer winglets.

11. The foil board of claim 10, where the at least two hydrofoil winglets turn in a downward direction, and the at least two stabilizer winglets turn in an upward direction.

12. The foil board of claim 10, where the at least two hydrofoil winglets turn in an upward direction, and the at least two stabilizer winglets turn in downward direction.

13. The foil board of claim 10, where the hydrofoil wing has at least two hydrofoil winglets and the stabilizer wing has at least two stabilizer winglets.

14. The foil board of claim 10, where the at least two hydrofoil winglets turn in an upward direction, and the at least two stabilizer winglets turn in an upward direction.

15. The foil board of claim 10, additionally comprising a battery compartment with a waterproof, detachable cover, where the battery compartment comprises a battery, a circuit board, and a plurality of electrical connections, where the plurality of electrical connection for a connection between the battery and the propulsion unit.

16. A foil board, comprising, a board, a forward mast, a rear mast, a propulsion unit, a stabilizer wing and a hydrofoil wing, where the board is removably attached to both the forward mast and the rear mast, where the rear mast is removably attached to an upper part of the propulsion unit and the hydrofoil wing is removably attached to a lower part of the propulsion unit, and there the forward mast is removably attached to the stabilizer wing.

17. The foil board of claim 16, where the hydrofoil wing has at least two hydrofoil winglets and the stabilizer wing both has at least two stabilizer winglets.

18. The foil board of claim 17, where the at least two hydrofoil winglets turn in a downward direction, and the at least two stabilizer winglets turn in an upward direction.

19. The foil board of claim 17, where the at least two hydrofoil winglets turn in an upward direction, and the at least two stabilizer winglets turn in downward direction.

20. The foil board of claim 19, additionally comprising a battery compartment with a waterproof, detachable cover, where the battery compartment comprises a battery, a circuit board, and a plurality of electrical connections, where the plurality of electrical connection for a connection between the battery and the propulsion unit.
